(19) United States
(12) Patent Application Publication
(10) Pub. No.: US 2016/0180170 A1
(43) Pub. Date: Jun. 23, 2016

(54) SYSTEMS AND METHODS FOR EYE TRACKING-BASED EXAM PROCTORING

(71) Applicant: D2L Corporation, Kitchener (CA)

(72) Inventors: Jeremy Auger, Kitchener (CA); David Halk, Kitchener (CA)

(21) Appl. No.: 14/576,153

(22) Filed: Dec. 18, 2014

(51) Int. Cl. G06K 9/00; G06T 7/20; G06F 17/30; H04N 5/44; H04N 7/18; G09B 7/00; G06K 9/62

(52) U.S. Cl. CPC G06K 9/00617; G09B 7/00; G06K 9/00604; G06T 7/20; G06K 9/0061; G06K 9/6215; H04N 5/44; H04N 7/181; G06F 17/3028; G06K 2009/00738; G06T 2207/30201; G06T 2207/30232

(57) ABSTRACT

A system for administering an activity to a participant, having at least one camera module configured to capture image data of at least one participant's eye, and at least one processor configured to receive a first plurality of images of the at least one eye, generate a first set of data of movements of the at least one eye, receive a second plurality of images of the at least one eye during a second time period, generate a second set of data of movements of the at least one eye based on the second plurality of images, and determine if at least one undesired event occurred based on the analysis of the activity data and the reference data for the participant.

### FIELD

Various embodiments are described herein that generally relate to systems and methods of administering an activity to multiple users, and particularly to administering an educational activity such as an examination.

### INTRODUCTION

Schools, educational institutions, and professional organizations have been recently moving towards online learning. Various activities administered online, particularly educational activities, such as exams, tests, or webinars, may require monitoring of one or more participants' behavior during the activity. Online proctoring is becoming a growing industry for ensuring academic integrity and exam credibility.

Currently available techniques of virtual proctoring normally require one proctor per student or participant (or at least per physical location of a number of students), which makes testing and/or monitoring of large groups of participants time consuming, complex, and expensive. In addition, it is hard to ensure academic integrity of the virtual proctoring because, for example, students can still converse with others in between tests to share answers or the like.

### DRAWINGS

For a better understanding of the various embodiments described herein, and to show more clearly how these various embodiments may be carried into effect, reference will be made, by way of example, to the accompanying drawings which show at least one example embodiment, and in which:

FIG. 1 is a block diagram illustrating an example embodiment of a system for assisting of administering an activity to participants;

FIG. 2 is a block diagram illustrating an example embodiment of a computing system for a participant to access the activity provider;

FIG. 3 is a flow chart diagram illustrating an example embodiment of a method of administering an activity to a participant; and

FIG. 4 is a flow chart diagram illustrating another example embodiment of a method of administering an activity to a participant;

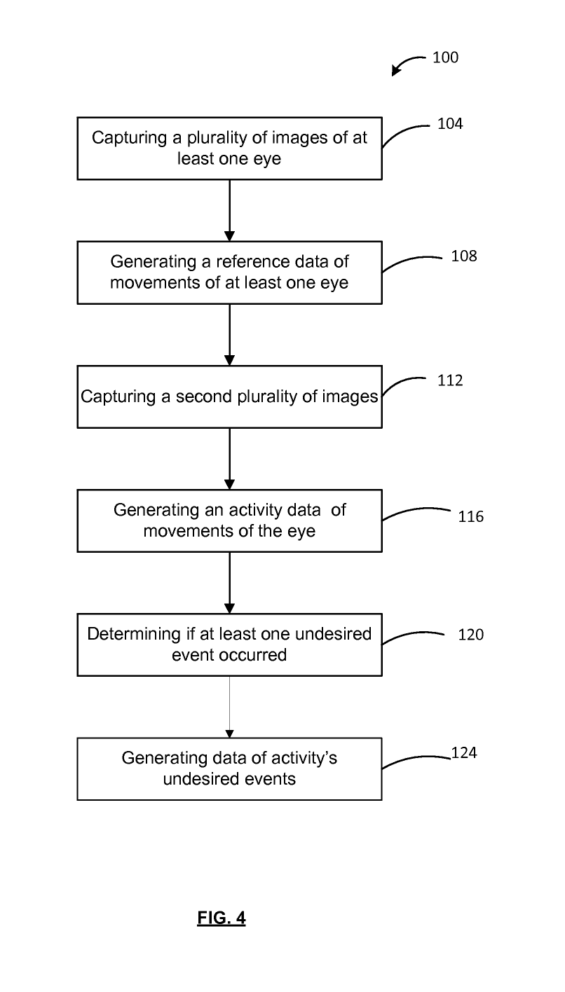

### DESCRIPTION OF VARIOUS EMBODIMENTS

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or processes described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein.

The various embodiments of the systems and methods described herein may be implemented in hardware or software, or a combination of both. For example, some embodiments may be implemented in computer systems and computer programs, which may be stored on a physical computer readable medium, executable on programmable computers (e.g. computing devices and/or processing devices) each comprising at least one processor, a data storage system (including volatile and non-volatile memory and/or storage elements), at least one input device (e.g. a keyboard, mouse or touchscreen), and at least one output device (e.g. a display screen, a network, or a remote server). For example, and without limitation, the programmable computers may include servers, personal computers, laptops, tablets, personal data assistants (PDA), cell phones, smart phones, gaming devices, and other mobile devices. Program code can be applied to input data to perform the functions described herein and to generate output information. The output information can then be supplied to one or more output devices for outputting to one or more users.

The embodiments described herein generally relate to systems and methods of administering an activity to one or more users, particularly an educational activity such as an examination.

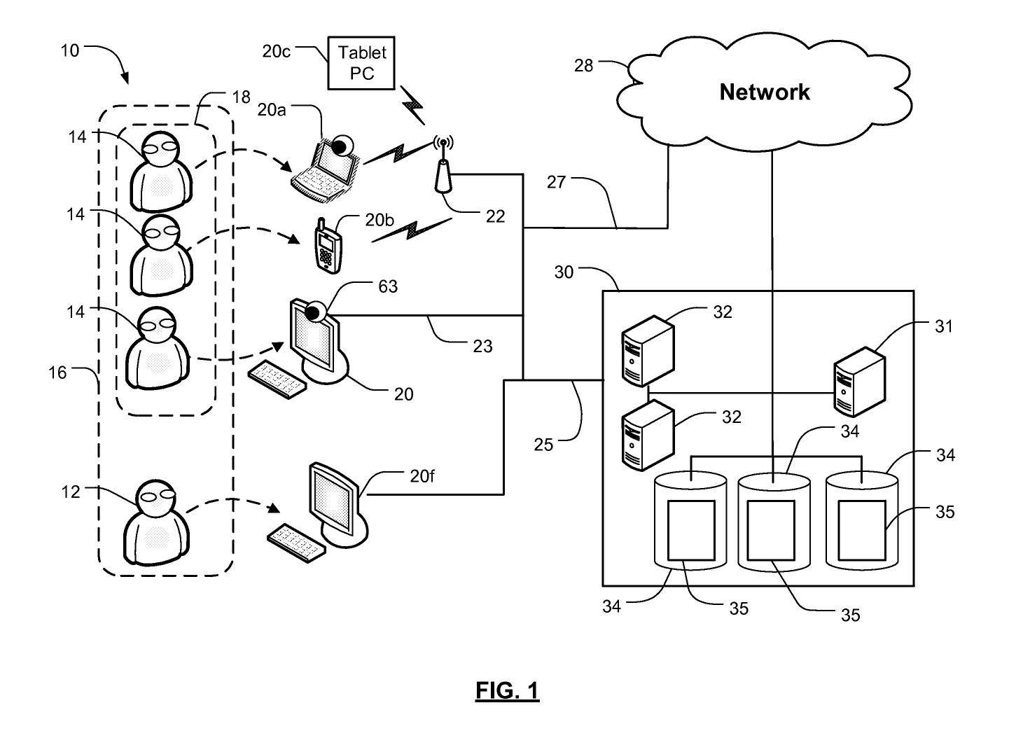

Referring now to FIG. 1, shown therein an example embodiment of a system 10 for administering an activity to one or more participants.

In general the system includes a facilitator 12 who can use the system 10 to facilitate the activity and monitor the academic integrity of one or more participant users 14 during the activity. One or more participant users 14 can use the system 10 to communicate with an educational service provider 30 in order to participate in the activity.

In some cases, the educational service provider 30 may be part of or associated with a traditional “bricks and mortar” educational institution (e.g. an elementary school, a high school, a university or a college), another entity that provides educational services and/or testing services (e.g. an online university, a company that specializes in offering proctoring activities or training activities, or an organization that has a training department), or may be an independent service provider (e.g. for providing individual electronic learning and testing).

For example, the activity may be a test, an exam, a proctored exam, a quiz, a training activity, a training event, an educational course, a seminar, a webinar or an educational service. The activity may also include any activity that is a part of another activity. In general, the activity may be any activity requiring proctoring and/or monitoring during the activity. In particular, the activity may need to be monitored to ensure a participant's academic integrity and/or the credibility of the activity.

It should be understood that an activity is not limited to formal proctoring exams, offered by formal educational institutions. The activity may include, for example, any form of testing offered by an entity of any type. For example, the activity may be a training seminar offered at a company for a small group of employees or a professional certification program with a larger number of intended participants (e.g., PMP, CMA, etc.).

To ensure the academic integrity, the facilitator 12 may monitor the participants 14 during the activity. In at least one exemplary embodiment, the facilitator 12 may receive data indicative of the activity's undesired event (or events) and review that data either during the activity or after the activity is terminated.

As used herein, “undesired event” generally refers to any event that may show that the integrity of the activity has been undermined or the results of the participant's performance are not credible because the participant might have used unauthorized support. An undesired event may occur, for example, if the participant is looking away from the screen or the keyboard, or if the participant is talking or whispering during the activity. For example, an undesired event may be an academic event, such as a participant cheating during an exam by speaking to another student or looking at prohibited materials (such as a textbook or notes).

In another example embodiment, the facilitator 12 may monitor the level of interest of the participants in the educational activity.

In some embodiments, one or more activity groups can be defined that involve one or more of the users 12 and 14. For example, as shown in FIG. 1, the users 12 and 14 may be grouped together in an activity group 16 representative of a particular activity (e.g. History 101 final test, French 254 midterm), in which the user 12 is a “facilitator” and is responsible for providing the activity (e.g. organizing a test, an exam, a lecture, a course, a webinar, etc.) and monitoring the academic integrity during the activity, while the other users 14 are “participants”.

It is to be understood that for each activity there may be more than one “facilitator”. In at least one example embodiment, one facilitator may develop the activity, while another facilitator may be monitoring the academic integrity during the activity or assessing the integrity of the participants 14 after the activity.

Generally, the “participants” can be viewed as consuming the activity (i.e, course or webinar, or participating in a test or exam). For example, the users 14 may be signed-up to take a test or participate in another activity. Users 14 that are “learners” or “test-takers” may be referred herein as “participant users 14”.

For example, at least one participant 14 may be registered to take an exam with the educational service provider 30. In at least one embodiment, more than one participant 14 may be physically in the same room during the activity. In another embodiment, each participant 14 is located in a separate room or distinct physical space (i.e., a cubical). Generally, the facilitator 12 may be physically in the same room as the at least one participant 14, or the facilitator 12 may be physically in different rooms, or even different cities, states or countries from the participants 14.

In some cases, the users 12 and 14 may be associated with more than one activity group. For instance, the participant users 14 may be enrolled in more than one activity and the facilitator user 12 may be enrolled in at least one activity and may be responsible for facilitating at least one other activity, or the facilitator user 12 may be responsible for facilitating more than one course.

In some cases, educational activity sub-groups may also be formed. For example, two of the users 14 are shown as part of an activity sub-group 18. The sub-group 18 may be formed in relation to a particular part of a test or assignment or based on other criteria. In some cases, due to the nature of the electronic learning, the users 14 in a particular sub-group 18 need not physically meet, but may need to collaborate together using various tools provided by the educational service provider 30.

Communication between the users 12 and 14 and the educational service provider 30 can occur either directly or indirectly using any suitable computing device. For example, the user 14 may use a computing device 20 such as a desktop computer that has at least one input device (e.g., a keyboard and a mouse) and at least one output device (e.g., a display screen and speakers).

The computing device 20 can generally be any suitable device for facilitating communication between the users 12 and 14 and the educational service provider 30. For example, the computing device 20 could be a laptop 20a wirelessly coupled to an access point 22 (e.g. a wireless router, a cellular communications tower, etc.), a wirelessly enabled personal data assistant (PDA) 20b or smart phone, a terminal 20 over a wired connection 23 or a tablet computer 20c or a game console over a wireless connection.

The computing devices 20 may be connected to the educational service provider 30 via any suitable communications channel. For example, the computing devices 20 may communicate to the educational service provider 30 over a local area network (LAN) or intranet, or using an external network, such as, for example, by using a browser on the computing device 20 to browse one or more web pages presented over the Internet 28 over a data connection 27.

The wireless access points 22 may connect to the educational service provider 30 through a data connection 25 established over the LAN or intranet. Alternatively, the wireless access points 22 may be in communication with the educational service provider 30 via the Internet 28 or another external data communications network.

In some cases, one or more of the users 12 and 14 may be required to authenticate their identities in order to communicate with the educational service provider 30. For example, the users 12 and 14 may be required to input a login name and/or a password or otherwise identify themselves to gain access to the system 10.

The educational service provider 30 generally includes a number of functional components for facilitating the provision of social electronic learning services. For example, the educational service provider 30 generally includes one or more processing devices 32 (e.g. servers), each having one or more processors. The processing devices 32 are configured to send information (e.g. HTML or other data) to be displayed on one or more computing devices 20, 20a, 20b and/or 20c in association with social electronic learning (e.g. course information). In some cases, the processing device 32 may be a computing device 20 (e.g. a laptop or a personal computer).

The educational service provider 30 also generally includes one or more data storage devices 34 (e.g. memory, etc.) that are in communication with the processing devices 32, and could include a relational database (such as an SQL database), or other suitable data storage devices. The data storage devices 34 are configured to host data 35 about the activities offered by the service provider. For example, the data 35 can include exam materials, testing materials, educational materials to be consumed by the users 14, records of assessments of users 14, assignments done by the users 14, as well as various other databases and the like.

The data storage devices 34 may also store authorization criteria that define which actions may be taken by the users 12 and 14. In some cases, the authorization criteria may include at least one security profile associated with at least one role. For example, one role could be defined for users who are primarily responsible for developing a seminar, teaching it, and assessing work product from students of the course. Users with such a role may have a security profile that allows them to configure various components of the course, to post tests or assignments, to add assessments, to evaluate performance, to monitor and/or assess the academic integrity of the participants 14, and so on.

In some cases, some of the authorization criteria may be defined by specific users who may or may not be part of the educational community 16. For example, these specific users may be permitted to administer and/or define global configuration profiles for the educational system 10, define roles within the educational system 10, set security profiles associated with the roles, and assign roles to particular users 12 and 14 who use the educational system 10. In some cases, these specific users may use another computing device (e.g. a desktop computer) to accomplish these tasks.

The data storage devices 34 may also be configured to store other information, such as personal information about the users 12 and 14 of the system 10, information about which activity the users 14 are enrolled in, roles to which the users 12 and 14 are assigned, particular interests of the users 12 and 14 and the like.

The data storage devices 34 may also store the profiles of the participants 14, which may contain data of the activities in which the participant 14 is or has been participating. The profiles may also contain the data of the activities' undesired events and/or the reference data and/or video, audio, or image data collected during the activity.

The processing devices 32 and data storage devices 34 may also provide other electronic learning management tools (e.g. allowing users to add and drop a seminar, etc.), and/or may be in communication with one or more other vendors that provide the tools.

In some cases, the educational system 10 may also have one or more backup servers 31 that may duplicate some or all of the data 35 stored on the data storage devices 34. The backup servers 31 may be desirable for disaster recovery to prevent undesired data loss in the event of an electrical outage, fire, flood or theft, for example.

In some cases, the backup servers 31 may be directly connected to the educational service provider 30 but located within the educational system 10 at a different physical location. For example, the backup servers 31 could be located at a remote storage location that is some distance away from the service provider 30, and the service provider 30 could connect to the backup server 31 using a secure communications protocol to ensure that the confidentiality of the data 35 is maintained.

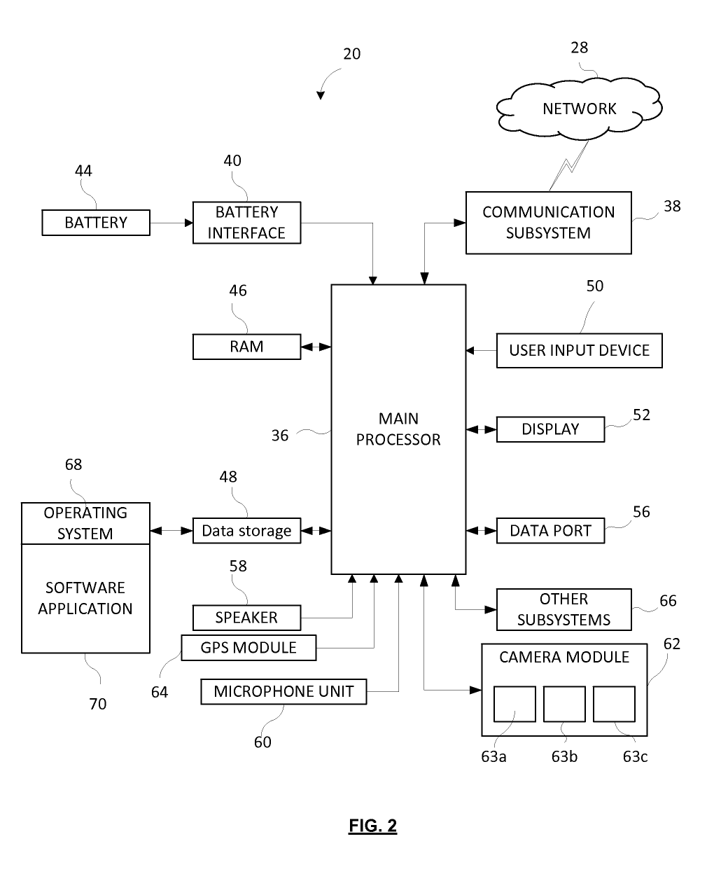

Referring now to FIG. 2, therein illustrated is a simplified block diagram of components of a computing device 20 according to one exemplary embodiment. The exemplary embodiment computing device 20 may be used by a participant 12 to participate in the activity. As shown, the computing device 20 includes multiple components, including for example a processor 36 that controls the operations of the computing device 20. Communication functions, including data communications, voice communications, or both may be performed through a communication subsystem 38.

The computing device 20 may be portable and may be a battery-powered device and as shown may include a battery interface 40 for receiving one or more batteries 44.

The processor 36 generally interacts with subsystem components such as a Random Access Memory (RAM) 46, a data storage device 48 (e.g. flash memory or hard drive), a user input device 50 and a display 52 (which may be a touch-sensitive display that can also be operated as the user input device 50). Information, such as text, characters, symbols, images, icons, and other items may be displayed on the display 52. The user input device 50 and the display 52 can be used by the participant user 14 to generate content items.

In some embodiments, user-interaction with the graphical user interface may be performed through touch sensitive display 52. In particular, the processor 36 may interact with the touch-sensitive display 52.

Other components could include one or more data ports 56, one or more speakers 58, a GPS module 64 and other device subsystems 66.

The computing device 20 also generally includes an operating system 68 and software components 70 that are executed by the processor 36. The operating system 68 and software components 70 may be stored in a persistent store such as the data storage device 48.

The computing device 20 may also comprise a microphone 60 and a camera module 62. The camera module 62 can be configured to capture image and/or video data. For example, the camera module 62 may be a webcam.

In at least one exemplary embodiment, the camera module 62 may comprise at least one camera unit 63a configured to capture image data and/or video data and to output the image/video data to the main processor 36 of the computing device 20 for further processing. For example, the at least one of the camera units 63 may be one of a webcam, a video camera, or a photo camera.

It should be understood that the camera module 62 may be built into the computing device 20 or the camera module 62 may be a separate device, operatively connected to the computing device 20. The camera units may be physically arranged in one single device, or may be separate devices operatively connected to the computing device 20 or main processor 36 of the computing device.

In at least one embodiment, the camera module 62 can capture a plurality of images. In at least one embodiment, the camera module 62 can capture a plurality of images of the participant and/or a plurality of images of the participant's at least one eye. In at least one exemplary embodiment, the camera module 62 may also capture video data. The camera module 62 may be configured to transmit the captured images to the main processor 36 or directly to at least one processing device 32. If the image data is transmitted to the main processor 36, the main processor may then transmit the image data to the processing device 32.

Referring back to FIG. 1, the processing devices 32 are also configured to receive a plurality of images and to analyze the plurality of images. The processing devices 32 may be configured to determine, based on the analysis of the image data and/or video data, if at least one undesired event has occurred during the activity.

The processing devices 32 may also be configured to generate a set of data of movements of the at least one eye of the participant based on the analysis of the first plurality of images. In at least one embodiment, the processing device 32 may be configured to determine a range of movement of the at least one eye of the participant based on the plurality of images.

The data storage devices 34 may also be configured to store the image data and data of the activity's undesired events for at least one participant. For example, the data storage devices 34 may store at least one user′ storage profile for at least one activity. For example, there may be one user's profile for all activities or one user's profile for each activity of the participant.

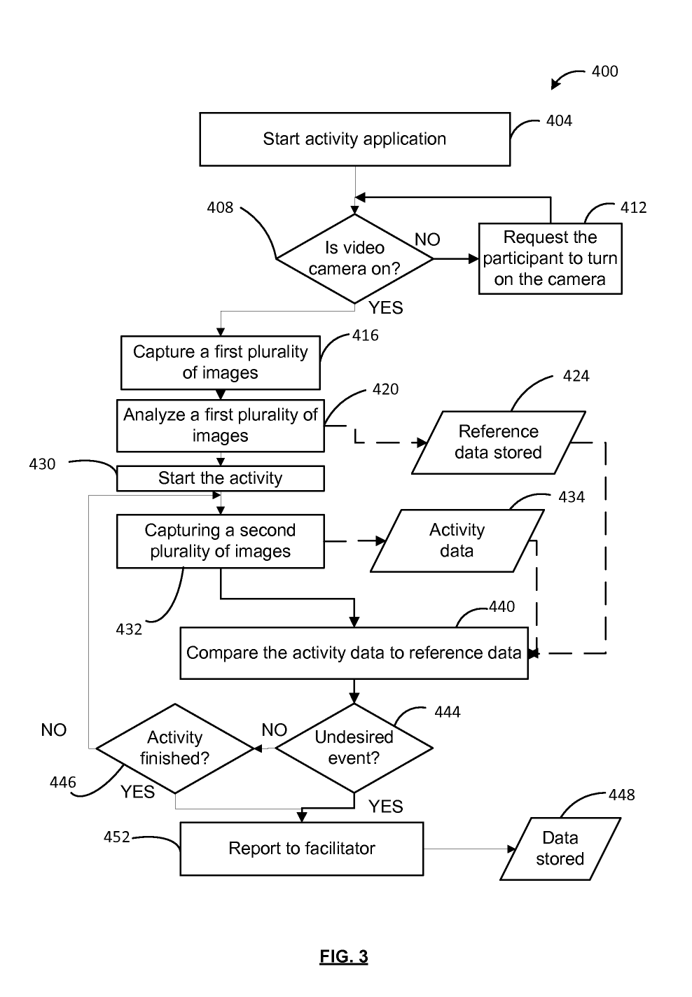

Referring now to FIG. 3, shown therein is a flow chart diagram illustrating an example embodiment of a method 400 of administering an activity to a participant 14. The method 400 may be performed by the processor 36 of a computing device 20 being used by the facilitator 12 or the participant 14, or by at least one processing device 32 of the educational service provider 30. Therefore, it should be understood that a “processor” herein may mean any one of the processor 36 of a computing device 20 being used by the facilitator 12 or the participant 14, or a processing device 32 of the educational service provider 30.

In some exemplary embodiments, steps of the method 400 may be split between the processor 36 of the computing device 20 and the processing device 32 of the educational service provider 30.

It should be understood that when discussing the system and/or the method implementing the processing device 32, the same method may be implemented using a plurality of processing devices 32.

It should also be understood that when referring below to “the participant” the same method and/or the system may be implemented for a plurality of participants.

At step 404, a new activity application is activated at the user's computing device 20. The activity application may be implemented in hardware or software on the computing device 20 and/or the processing devices 32 of the educational service provider 30.

In various example embodiments, the activity application can be activated following the activation request received from the facilitator 12. In other example embodiments, the test may be activated by the participant user 14.

After the activity application has been activated, the application may verify if the microphone unit 60 and the camera module 62 are turned on. If at least one of the microphone unit 60 or the camera module 62 is off, the activity application requests to turn on the microphone unit 60 and the camera module 62. If the camera module 62 is turned on, then the AA proceeds to a calibration test,

At step 416, a first plurality of images of at least one eye of the participant user is captured during a first time period. The plurality of images may be captured by the camera module 62 of the participant's computing device 20 and then transmitted to the main processor 36. The main processor may then transmit the data to the processing device 32.

In at least one embodiment, the activity application performs the calibration test to establish a baseline measurement of the user's normal eye movements and to generate reference data. The time period of the calibration test may be either pre-determined or depend on the image data captured and determined by the AA during the execution of the calibration test. For example, this time period may depend on the quality of images acquired.

In at least one embodiment, the images captured by the camera module 62 may be images of the participant 14, and/or images of at least one participant's eye. For example, the camera module 62 may have two camera units 63 each capturing image data of eye movements at least one eye of the participant 14. In another example, one camera unit 63 may capture image data of both eyes at the same time.

In at least one embodiment, the camera module 62 may need to be focused on the participant's one eye or both eyes. For example, the application may ask the participant 14 to change the position of the camera module 62. For example, the application may show the image on the screen of the computing device 20 and provide instructions to the participant 14 to physically adjust the position of the camera module 62 or of the camera units 63.

In at least one embodiment, the application may operate the camera module 62 and the application may analyze the images captured and adjust physical position of the camera module 62. In at least one embodiment, the facilitator 12 may provide instructions to the participant 14 regarding adjusting the physical position of the camera module 62.

The captured plurality of images may contain images of a pupil, an iris, a retina, or an eyelid of the eye of the participant 12. It should be understood that the images may be focuses only on one portion of the eye (e.g. a pupil, an iris, a retina, or an eyelid of the eye), or on more than one parts of the eye of the participant.

The captured images of the participant's eye are then sent to the main processor 36 of the computing device 20. The main processor may either analyze the image data or transmit the image data further to the processing device 32 for the analysis.

The plurality of images may be analyzed (at step 420) using algorithms to determine a first range of movement of the at least one eye of the participant 14. The analysis may be performed either in the real time, i.e. during capturing of the image data, or after the plurality of images has been captured.

At step 424 a reference data of movements of the at least one eye of the participant user is generated based on the analysis of the first plurality of images.

At the same time, a reference audio data may also be generated by the microphone unit 60. In at least one embodiment, the microphone unit 60 may also need to be adjusted physically. For example, the application may ask the participant 14 to physically move the microphone unit 60. For example, the application may ask the participant 14 to read a text out loud and/or to whisper. The application may also run an audio example using the speaker 58 of the computing device. The application may then analyze the audio data captured by the microphone unit 60 to generate audio reference data. For example, a threshold of acceptable noise may be determined.

The determined threshold may be used further to determine if the participant 14 is whispering during the activity or if he is receiving any audio aid, which is unauthorized during the activity.

The image data, video data, and audio data captured during the first period of time and the reference data generated may be stored at the at least one data storage device 34. For example, the data may be stored in the participant's profile. For example, the reference data of movements of the participant's eye and/or portions of the eye may be stored in the participant's profile. The data may also be stored in the data storage 48 of the computing device 20.

At step 430, the application starts the activity. During the activity, the camera module 62 captures a plurality of data images and transmits them to the processor 36 and/or processing device 32. The camera module 62 may also capture video data and transmit it to one of the processors.

For example, the camera module 62 may capture the image data (at step 432) during the second period of time and then transmit the data in batches to the processing device 32. In another example, each image is transmitted separately. The camera module 62 may also capture video data and transmit it to the processor 36 and/or processing device 32. For example, the processing device 32 may then extract a plurality of images from the video data.

During the same second time period of time, the microphone unit 60 may capture the audio data and transmit this audio data to one of the processors.

It should be understood that the second time period may be the time period corresponding to the full duration of the activity, or it may be a shorter time period. For example, the time period may be pre-determined or determined as a function of the duration of the activity (e.g. a certain number of time periods per activity). For example, the time period may be determined based on the results of the calibration test. In at least one example embodiment, the facilitator 12 may determine the time period, for example, at the start set-up of the application.

Based on the analysis of the image data, the processing device 32 may determine the range of movements of the participant's eye and/or range of movement of the participant's portion of the eye, generating activity data (step 434).

The processor may also analyze the audio data captured during the second time period and compare it to the audio data captured during the first time period, i.e. the reference audio data. For example, the processing device may compare the audio data captured during the second time period to the audio threshold determined based on the audio data captured during the first time period.

At step 440, the processor may compare the image data captured during the second period of time to the image data captured during the first period of time. For example, the processor may compare the range of movement of the eye and/or retina determined for the first period of time and the second period of time.

At step 444, based on the comparison of the first set of data with the second set of data, the processor may determine if an undesired event has occurred. For example, the processor may calculate a difference between a first range of movement and a second range of movement of the at least one eye of the participant and/or portion of the eye of the participant. For example, an undesired event may occur if this difference exceeds a predetermined threshold. For example, this threshold may be pre-determined in the application, or the application may have determined this threshold during the calibration test.

For example, the generated data of activity's undesired events may comprise a flagging system and/or a cheating index. For example, the cheating index may be similar to Turnitin's scale.

In at least one embodiment, if the undesired event has occurred during the second time period, the processor may send an alert to the facilitator 12 immediately. For example, the processor may send an alert along with the video data and/or audio data captured during the second time period. For example, the processor may also send image data collected to the facilitator 12. In at least one embodiment, the facilitator 12 may review the video and/or audio data. For example, the facilitator 12 may start monitoring the real-time video of the participant, or reject the alert.

In at least one embodiment, the processing device 32 may collect the video, image, and/or audio data for the participant and analyze it, time period after time period, for the whole activity. If the processor determines that during the whole time period there has been at least one undesired event, the processor may then, based on the analysis, send the data collected and/or the results of the analysis to the facilitator 12. For example, an alert may be sent to the facilitator 12 along with the video data and/or audio data captured during the second time period. For example, the image data collected may also be transmitted to the facilitator 12.

For example, the facilitator 12 may receive the information of an undesired event from the educational service provider 30, from the participant's computing device 20, and/or from the camera module 62 directly.

For example, the facilitator 12 may also receive image data and/or video data from the educational service provider 30, from the participant's computing device 20, and/or from the camera module 62 directly. The facilitator may also receive sound data from the educational service provider 30, from the participant's computing device 20, and/or from the microphone 62 directly.

The data of the activity's undesired events may be stored on the storage device 34 or any other storage device.

The facilitator 12 may then analyze the alert and the video and/or audio data received and accept or reject the system's recommendation. All data of the acceptance or rejection of the system's recommendation may be further sent, along with the audio/video data and image data, to a centralized database to further improve the system's accuracy.

In at least one embodiment, the system may comprise a wearable device. The application may collect the data describing a location of the participant's eye focus from the wearable device. The collected data may then be used to determine the focus of the participant's eye and the video data seen by the participant 14 may be recorded. This video data seen by the participant may then be sent the facilitator 12 along with generated data of activity.

1. A method of administering an activity to a participant, the method comprising:
capturing a first plurality of images of at least one eye of the participant during a first time period;
generating a reference data of movements of the at least one eye of the participant based on the analysis of the first plurality of images;
capturing a second plurality of images of the at least one eye of the participant during a second time period;
generating an activity data of movements of the at least one eye of the participant based on the analysis of the second plurality of images;
determining if at least one undesired event occurred based on the analysis of the activity data and the reference data for the participant; and
generating data of activity's undesired events for the participant.

2. The method of claim 1, further comprising
transmitting the data of activity's undesired events to a facilitator.

3. The method of claim 1, further comprising:
determining a first range of movement of the at least one eye of the participant based on the first plurality of images;
determining a second range of movement of the at least one eye of the participant based on the second plurality of images;
determining a difference between a first range of movement and a second range of movement of the at least one eye of the participant; and
adding the determined difference to the generated data of activity's undesired events, if the difference exceeds a threshold.

4. The method of claim 1, further comprising:
receiving data from a video monitoring system on a wearable device, the data describing a location of the participant's eye focus;
recording the video data seen by the participant; and
sending the video data seen by the participant and the generated data of activity's undesired events to a facilitator.

5. The method of claim 1, further comprising:
capture video data of the participant during the activity; and
transmitting the recorded video data and the generated data of activity's undesired events to a facilitator.

6. The method of claim 4, further comprising:
receiving a response from the facilitator;
transmitting the response and the generated data of activity's undesired events to a centralized database.

7. The method of claim 1, wherein the activity is chosen from one of a proctor exam and a training event.

8. The method of claim 1, wherein an undesirable event is participant's cheating.

9. The method of claim 1, wherein the generated data of activity's undesired events further comprises at least one of a flagging system and a cheating index.

10. The method of claim 1, further comprising
storing at least one set of data of movements of the at least one eye of the participant in a participant's profile.

11. The method of claim 1, further comprising
storing the data of activity's undesired events on a storage device.

12. The method of claim 1, further comprising:
generating an alert if an undesired event has occurred; and
transmitting the alert to a facilitator.

13. A system for administering an activity to a participant comprising:
at least one camera module configured to capture image data of at least one participant's eye;
at least one processor configured to:
receive a first plurality of images of the at least one eye of the participant captured during a first time period;
generate a first set of data of movements of the at least one eye of the participant based on the analysis of the first plurality of images;
receive a second plurality of images of the at least one eye of the participant captured during a second time period;
generate a second set of data of movements of the at least one eye of the participant based on the analysis of the second plurality of images;
determine if at least one undesired event occurred based on the analysis of the activity data and the reference data for the participant; and
generate data of activity's undesired events;
and
at least one storage device configured to store the image data and data of activity's undesired events.

14. The system of claim 13, wherein the at least one processor is configured to:
determine a first range of movement of the at least one eye of the participant based on the first plurality of images;
determine a second range of movement of the at least one eye of the participant based on the second plurality of images;
determine a difference between a first range of movement and a second range of movement of the at least one eye of the participant; and
add the determined difference to the generated data of activity's undesired events, if the difference exceeds a threshold.

15. The system of claim 13, wherein the at least one processor is configured to transmit the data of activity's undesired events to a facilitator;

16. The method of claim 13, wherein the at least one processor is configured to:
determine a first range of movement of the at least one eye of the participant based on the first plurality of images;
determine a second range of movement of the at least one eye of the participant based on the second plurality of images;
determine a difference between a first range of movement and a second range of movement of the at least one eye of the participant; and
add the determined difference to the generated data of activity's undesired events, if the difference exceeds a threshold.

17. The system of claim 13, wherein the at least one processor is configured to transmit the data of activity's undesired events to a facilitator.

18. The system of claim 13, wherein the system further comprises a video monitoring system on a wearable device configured to
capture the location of the participant's eye focus;
record the video data seen by the participant; and
send the video data seen by the participant and the generated data of activity's undesired events to a facilitator.

19. The system of claim 13, wherein the system is further configured to:
capture video data of the participant during the activity; and
transmit the recorded video data and the generated data of activity's undesired events to a facilitator.

20. The system of claim 13, wherein the system further comprises a centralized database with at least one of image data, video data, and analysis data.
